(19) United States
(12) Patent Application Publication
(10) Pub. No.: US 2005/0096091 A1
(43) Pub. Date: May 5, 2005

(54) Method and system for wireless communications using multiple frequency band capabilities of wireless devices

(76) Inventor: Jacob Sharony, Dix Hills, NY (US)

Correspondence Address: OLEG F. KAPLUN;FAY KAPLUN & MARCIN, LLP, 150 BROADWAY, SUITE 702, NEW YORK, NY, 10038, US

(21) Appl. No.: 10/699,270

(22) Filed: Oct. 31, 2003

(51) Int. Cl. H04B 1/00

(52) U.S. Cl. 455/562.1; 370/319; 455/63.4; 455/73

(57) ABSTRACT

A system for wireless communication utilizing a first wireless band and a second wireless band. The system including a first dual-band wireless transceiver and a smart antenna, the first device, using the smart antenna, uni-directionally transmitting payload data exclusively on the first band without having to reserve the first band prior to transmission and at least one second wireless device including a second dual-band wireless transceiver, the second device acknowledging reception of the payload data using at least one of the first and second bands by omni-directionally transmitting acknowledgment data.

### BACKGROUND OF THE INVENTION

The proliferation of conventional wireless computing devices in recent years has been exceptional. In a wireless communication network, these devices act as mobile units (“MUs”) which are capable of exchanging data and/or voice signals among each other and/or with a central access point (“AP”) connected to the wired network using radio waves over dedicated frequencies or dedicated segments of the electromagnetic spectrum. The speed and range of these wireless communications is limited by, among other things, interference and power limitations. There is an ongoing effort to overcome these issues and to make these wireless communications as fast as their wired cousins and to increase their effective range.

A typical wireless communication network may include multiple MUs communicating with other wireless devices on the network. Examples of MUs include laptop computers, PDAS, cell phones or two-way pagers. Communications on the wireless network may occur via, e.g., radio frequency (“RF”) signals. APs are network elements having both wireless and wired communications capability. The APs allow the MUs to communicate with elements on a wired network (i.e., servers, telephones, fax machines) and vice versa. Thus, the APs may be routers or transceiver boxes that provide access for the MUs to the wireless and wired networks. These APs manage the bi-directional data flow across the interface between the wireless and wired networks. The data flowing from the wired network to MUs on the wireless network is said to flow “downstream” and data flowing from the MUs to units on the wired network flows “upstream”.

Wireless networks may operate in a single band of the electromagnetic spectrum. For example, the IEEE 802.11b standard establishes wireless networks in the 2.4-2.4835 Ghz band. These single-band networks enable multiple simultaneous wireless communication paths by dividing the band into a number of discrete channels. The number of channels depends upon several factors, such as geographical location, etc. For example, the 802.11b standard divides the 2.4 Ghz band into 11 channels in the United States, Canada and Taiwan, and 14 channels in Japan.

Some wireless networks may operate in two different frequency bands. These dual-band networks have the option of transmitting data over a low-frequency (“LF”) band or a high-frequency (“HF”) band. For example, a dual-band network may be equipped to transmit wireless data over both the 2.4 Ghz band (“the LF band”) using the 802.11b or 802.11g standards and the 5 Ghz band (“the HF band”) using the 802.11a standard. The dual-band systems have the advantage of increasing the number of simultaneous wireless data streams that can be sent by increasing the number of independent wireless channels in use at any one time.

One of the major functions performed by the APs in a wireless network is to allocate each of the multitude of data packets moving downstream to one of the discrete number of wireless channels contained within the wireless network. This function needs to be performed regardless of whether the wireless network uses one or more frequency bands. The AP must ensure that each channel is not being utilized for more than one transmission in any given instant to avoid collisions and resulting transmission failure.

A conventional method for handling this task is to use a Request-to-Send/Clear-to-Send (“RTS/CTS”) system, for example the kind described in the 802.11 standard. FIG. 1 shows this conventional method for an RTS/CTS mechanism in a wireless network.

In step 100, an AP transmits a request-to-send (“RTS”) broadcast over the wireless network. This-RTS broadcast may be sent omni-directionally so that it can be received by all MUs on the wireless network. The RTS broadcast may include information such as data rate and packet length or any other information that can be used by the MUs to determine the length of the reservation. In other words, the RTS broadcast asks all of the MUs on the wireless network to refrain from transmitting data on a particular channel so that the AP can use that channel to deliver a payload data to a target MU. The payload data may be any type of data that the user of the MU has requested, for example a web page, an email message, an audio or video file, or a portion of a phone call.

In step 102, the target MU responds to the RTS broadcast by sending a clear-to-send (“CTS”) broadcast over the wireless network. The CTS broadcast may also be transmitted omni-directionally and received all other MUs on the network. The CTS broadcast effectively notifies that the requested channel will not be used during the time required to transmit the payload data to the target MU.

In step 104, the AP transmits uni-directionally to the target MU the payload data using a smart antenna (“SA”). The payload should be delivered within the period of time reserved in the RTS broadcast, otherwise the payload could collide with a second data transmission from another MU which mistakenly “believes” that the channel is free.

In step 106, the target MU may broadcast an acknowledgment data signal back to the AP. This data signal may indicate to the AP that the payload data has been received by the target MU. The acknowledgment signal may be sent over omni-directionally.

In step 108, normal operations may resume on the wireless network. Other MUs on the network are free to use the wireless channel over which the payload data has been sent and received.

The conventional method described above aims at preventing collisions on the wireless network. However, to do so it requires that a high number of extra data broadcasts be sent. Each payload data transmission must be preceded by a series of RTS and CTS broadcasts. As more MUs are added onto the wireless network, the number of such preliminary broadcasts increases. A method is needed which obviates the need for this preparatory network traffic.

### SUMMARY OF THE INVENTION

A system for wireless communication utilizing a first wireless band and a second wireless band, comprising a first wireless device including a first dual-band wireless transceiver and a smart antenna, the first device, using the smart antenna, uni-directionally transmitting payload data exclusively on the first band without having to reserve the first band prior to transmission and at least one second wireless device including a second dual-band wireless transceiver, the second device acknowledging reception of the payload data using at least one of the first and second bands by omni-directionally transmitting acknowledgment data.

A method for wireless communications, comprising uni-directionally transmitting payload data by a first wireless device to at least one second wireless device on a first band, the first device using a smart antenna for the transmission of the payload data, the first device transmitting the payload data without having to reserve the first band and after the first step a, omni-directionally transmitting acknowledgment data by the second device to acknowledge receipt of the payload data using at least one of the first and second band.

A wireless device, comprising a dual-band wireless transceiver capable of wirelessly transmitting using first and second wireless bands and a smart antenna, wherein payload data is uni-directionally transmitted using the smart antenna on the first band without having to reserve the first band prior to the transmission of the payload data, and wherein the transceiver omni-directionally transmits further payload data on the second band having reserved the second band prior transmitting the further payload data.

### BRIEF DESCRIPTION OF THE DRAWINGS

FIG. 1 shows a conventional method of an RTS/CTS mechanism utilized for wireless communications;

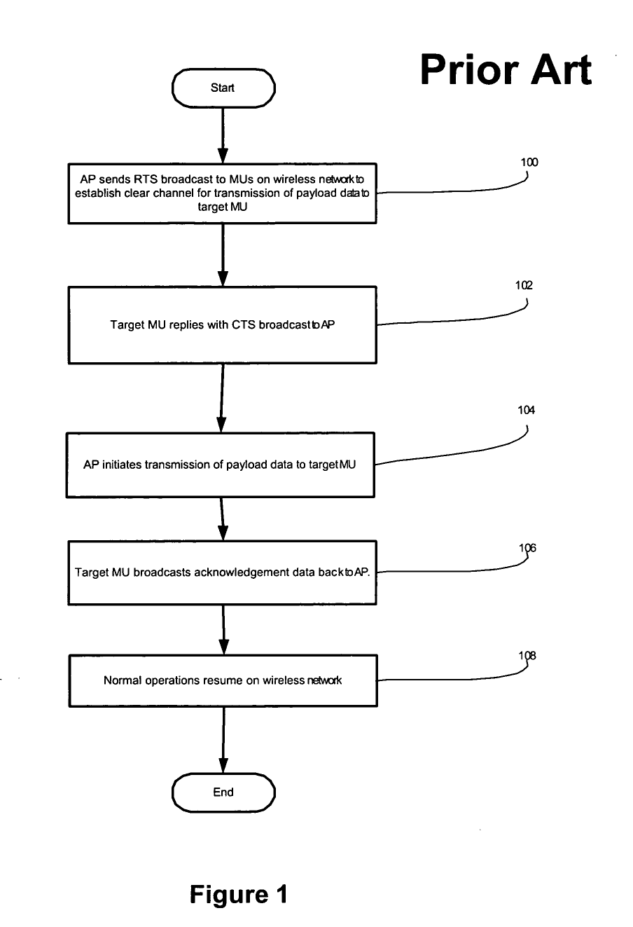

FIG. 2 shows an exemplary embodiment of a wireless network according to the present invention;

FIG. 3 shows an exemplary method according to the present invention; and

FIG. 4 shows an exemplary embodiment of data transmission over the wireless network according to the present invention.

### DETAILED DESCRIPTION

The present invention relates to a method and system for utilizing the dual-band capability of wireless devices. According to the present invention, the channels on the HF band are reserved for downstream (e.g., server to workstation, or AP to MU) data transmissions and all of the channels on the LF band are reserved for upstream (e.g., MU to AP) data transmissions. APs may use smart antennae (“SA”) to broadcast downstream HF data transmissions uni-directionally. MUs broadcast upstream LF transmissions omni-directionally.

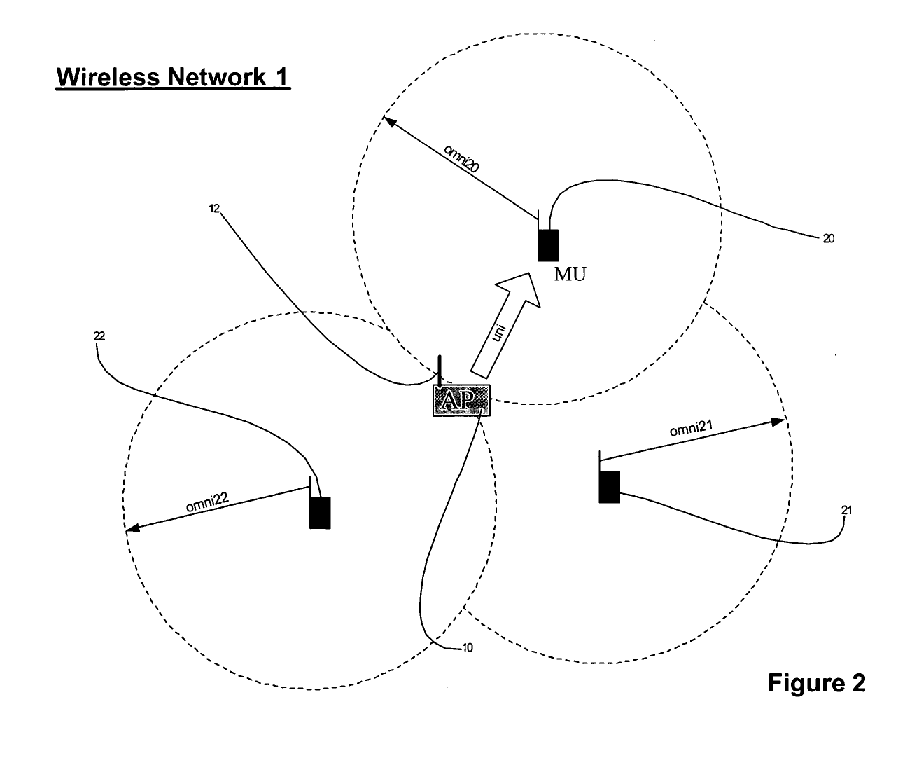

FIG. 2 shows an exemplary embodiment of a wireless network 1 according to the present invention. The wireless network 1 may include a plurality of wireless computing devices (e.g., MUs 20-22) and a plurality of access points (e.g., AP 10). All of the MUs 20-22 are located within the uni-directional transmission coverage area of the AP 10, while the AP 10 is located within the omni-directional transmission coverage area of MUs 20-22. The AP 10 may transmit data to the MUs 20-22 using a SA 12 to send the uni-directional transmission over the HF band. The MUs 20-22 may broadcast data to the AP 10 using the omni-directional transmissions over the LF band. Because the MUs may not send data broadcasts over the HF band (may not use the channels located in the HF band), there is no need for the AP 10 to use a system such as an RTS/CTS mechanism to reserve exclusive use of such a channel. Therefore, additional data transmissions associated with RTS and CTS messages are unnecessary.

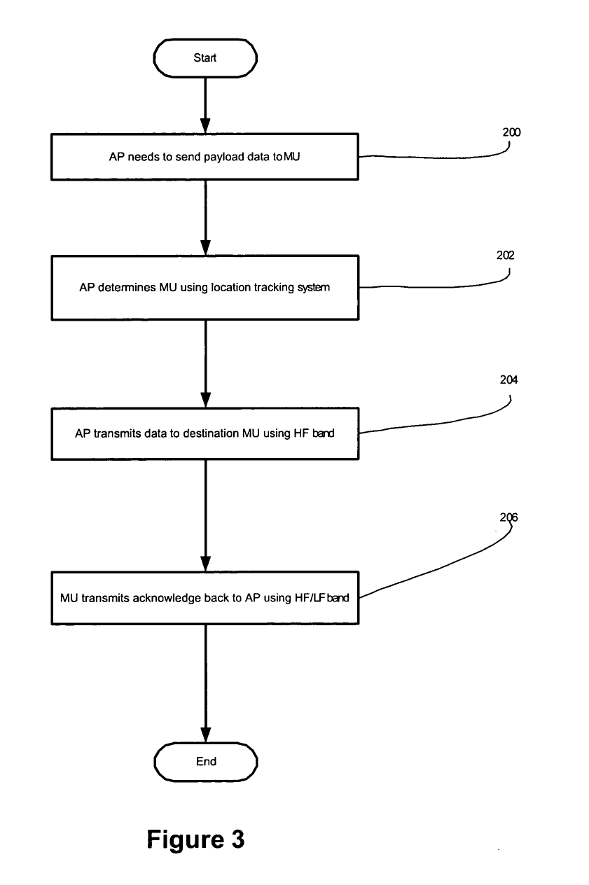

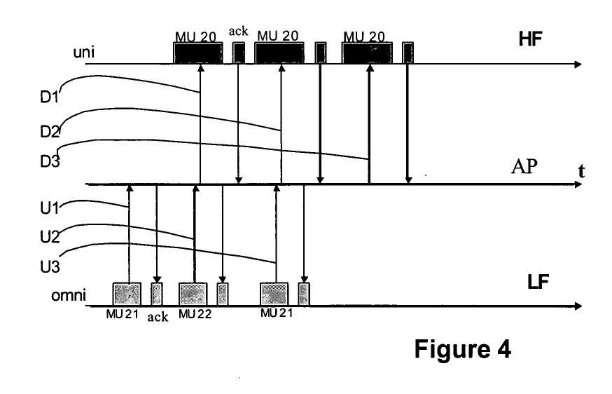

FIG. 3 shows an exemplary method according to the present invention. The method will be described with reference to FIGS. 2 and 4. Other configurations with different numbers of MUs and/or APs may also be used.

In step 200, the AP 10 has payload data that is destined for an MU 20 communicating on the wireless network 1. The payload data may be a part of any data type, such as an email message, an audio or video file, a text message, etc. Since the payload data is sent from the AP 10 to the MU 20, the AP 10 may utilize the HF band to send the payload data.

In step 202, the AP 10 may locate the position of the destination MU 20 using one of several real-time location systems (“RTLSs”) with which the AP 10 may be equipped. For example, the AP 10 may have a received signal strength indicator (“RSSI”) or use a time-distance of arrival (“TDOA”) system. These or similar systems use conventional technologies to determine a location (e.g., the distance and angle) of the destination MU 20 relative to the AP 10.

In step 204, the AP 10 may use the location information obtained in step 202 to send the payload data. The payload data is sent to the MU 20 over the HF band. The AP 10 may utilize the SA 12 to transmit the payload data via the uni-directional transmission. Since the payload data is addressed to the MU 12 and it is sent over the HF band, the destination MU 20 is the only MU in the wireless network 1 which receives this uni-directional transmission; the other MUs 21-22 may be “unaware” that the payload data is being sent to MU 20 on the HF band. Since the non-destination MUs 21-22 may not be using the HF band, there is no risk that there will be a collision on this HF band with the payload data.

Once the MU 20 receives the payload data from the AP 10, the MU 20 sends an acknowledgment back to the AP 10. The acknowledgment indicates the payload data was safely received by the MU 20. The acknowledgment may be sent back to the AP 10 over the HF band. Since the AP 10 just finished transmission of the payload data to the MU 20, the AP 10 will await the acknowledgment from the MU 20, thus the HF band will not be utilized and no collision would occur. In addition, since the acknowledgment is relatively short, the AP 10's wait time is short. Alternatively, the MU 20 may send the acknowledgment to the AP 10 over the LF band.

One of the advantages of the present invention is that the transmission of the payload data from the AP 10 to the MU 20 over the HF band may occur simultaneously with the transmission from, e.g., the MU 21 to the AP 10 over the LF band. Since the two transmissions are occurring on different frequency bands, there is no possibility of collision.

FIG. 4 shows an exemplary embodiment of data transmissions over the network described by the present invention. Three sequential downstream data transmissions D1-D3 may be sent by the AP 10 to destination MU 20, while at the same time non-destination MUs 21 and 22 may be sending three upstream data transmissions U1-U3 to the AP 10. The top and bottom horizontal axes in the diagrams represent activity on the high and low frequency bands respectively over time. No upstream payload data may use the HF band and no downstream payload data may use the LF band. The only upstream data which may use the HF band are acknowledgment data (“ack”) transmissions indicating that an MU 20-22 has received the payload data from the AP 10. Similarly, in this example, the only downstream data which may use the LF band are ack transmissions indicating that AP 10 has received the payload data from MUs 20-22. However, because the ack transmissions have a significantly smaller size than the payload data transmissions, they may travel the “wrong way” on the two frequency bands with little risk of a collision with a payload data on the same channel. The AP 10 may be equipped to send downstream payload data transmissions to the MUs 21-23 on the LF band. However, this would require data handshakes and/or reservation of the LF band.

The system and method of the present invention possess several advantages over conventional systems which utilize the RTS/CTS mechanism described above. For example, the present invention greatly reduces the overhead of wireless networks by making preparatory transmissions (e.g., RTS/CTS broadcasts) unnecessary.

Another advantage of the present invention is that the system and method of using uni-directional transmissions on the HF band and omni-directional transmissions on the LF band causes the LF and HF coverage areas to be substantially similar. At equal power outputs, the coverage area of LF bands is significantly greater than that of HF bands. Focusing the available power of the HF band for the uni-directional transmission significantly increases the range of the HF band, to the point where the coverage range largely overlaps that of the omni-directional transmission over the LF band. Another advantage of the present invention over conventional wireless networks is that the wireless network 1 is able to accommodate a larger number of MUs by limiting downstream transmissions to the HF band. Since the majority of wireless network traffic consists of downstream data transmissions, utilizing the HF band for these transmissions results in relatively low overall traffic on the LF band. This increased capacity may be used to handle the transmission needs of more MUs. Finally, by giving exclusive use of the HF band to the AP 10, the wireless network 1 experiences shorter delay times and greater overall throughput.

The present invention has been described with reference to an embodiment having MUs and AP. However, other embodiments may be devised having additional APs and/or additional or fewer MUs. Accordingly, various modifications and changes may be made to the embodiments without departing from the broadest spirit and scope of the present invention as set forth in the claims that follow. The specification and drawings are accordingly to be regarded in an illustrative rather than restrictive sense.

1. A system for wireless communication utilizing a first wireless band and a second wireless band, comprising:
a first wireless device including a first dual-band wireless transceiver and a smart antenna, the first device, using the smart antenna, uni-directionally transmitting payload data exclusively on the first band without having to reserve the first band prior to transmission; and
at least one second wireless device including a second dual-band wireless transceiver, the second device acknowledging reception of the payload data using at least one of the first and second bands by omni-directionally transmitting acknowledgment data.

2. The system according to claim 1, wherein the second device omni-directionally transmits further payload data using only the second band, the second device reserving the second band prior to transmission of the further payload data.

3. The system according claim 1, wherein the first band is 5 Ghz band and the second band is a 2.4 GHz band.

4. The system according to claim 1, wherein prior to uni-directionally transmitting the payload data via the first band, the first device determining location of the second device.

5. The system according to claim 1, wherein the first device omni-directionally transmits data using the second band to the second device, the first device reserving the second band prior to the transmission.

6. The system according to claim 2, wherein the uni-directional transmission of the payload data from the first device to the second device via the first band and the omni-directional transmission of the further payload data from the second device to the first device via the second band are simultaneous.

7. The system according to claim 6, wherein coverage areas of the corresponding uni-directional and omni-directional transmissions are substantially similar.

8. The system according to claim 1, wherein the first device is an access point.

9. A method for wireless communications, comprising:
a) uni-directionally transmitting payload data by a first wireless device to at least one second wireless device on a first band, the first device using a smart antenna for the transmission of the payload data, the first device transmitting the payload data without having to reserve the first band; and
b) after the step a, omni-directionally transmitting acknowledgment data by the second device to acknowledge receipt of the payload data using at least one of the first and second band.

10. The method according to claim 9, further comprising:
omni-directionally transmitting further payload data by the second device to the first device using the second band, the second device having reserved the second band prior to transmission of the further payload data.

11. The method according claim 9, wherein the first band is 5 Ghz band and the second band is a 2.4 GHz band.

12. The method according to claim 9, further comprising:
prior to uni-directionally transmitting the payload data via the first band, determining a location of the second device.

13. The method according to claim 9, further comprising:
omni-dimensionally transmitting by the first device data using the second band to the second device, the first device reserving the second band prior to the transmission.

14. The method according to claim 9, wherein the uni-directional transmission of the payload data from the first device to the second device via the first band and the omni-directional transmission of the further payload data from the second device to the first device via the second band are simultaneous.

15. The method according to claim 14, wherein coverage areas of the corresponding uni-directional and omni-directional transmission substantially similar.

16. A wireless device, comprising:
a dual-band wireless transceiver capable of wirelessly transmitting using first and second wireless bands; and
a smart antenna,
wherein payload data is uni-directionally transmitted using the smart antenna on the first band without having to reserve the first band prior to the transmission of the payload data, and
wherein the transceiver omni-directionally transmits further payload data on the second band having reserved the second band prior transmitting the further payload data.

17. The device according to claim 16, wherein the device is an access point.

18. The device according claim 16, wherein the first band is 5 GHz band and the second band is a 2.4 GHz band.

19. The device according to claim 16, wherein prior to uni-directionally transmitting the payload data via the first band, the device determines a location where the payload data is to be transmitted.

20. The device according to claim 19, wherein the uni-directional transmission of the payload data via the first band and the omni-directional transmission of the further payload data via the second band are simultaneous.

21. The device according to claim 20, wherein coverage areas of the corresponding uni-directional and omni-directional transmissions are substantially similar.
